(19) United States
(12) Patent Application Publication
(10) Pub. No.: US 2026/0338004 A1
(43) Pub. Date: Oct. 29, 2026

(54) LOCKING DEVICE

(71) Applicant: STENDALS EL AB, VÄSTERÅS (SE)

(72) Inventor: Anders HANNU, VÄSTERÅS (SE)

(21) Appl. No.: 19/121,285

(22) PCT Filed: Oct. 16, 2023
(86) PCT No.: PCT/SE2023/051026

§ 371 Date: Apr. 15, 2025

(30) Foreign Application Priority Data
Oct. 17, 2022 (SE) 2251215-6

(51) Int. Cl. E05B 47/00

(52) U.S. Cl. CPC E05B 47/0012; E05B 2047/0016; E05B 2047/002

(57) ABSTRACT

The present invention relates to a locking device comprising—a housing (10)—a first bolt (30) comprising a pivotable bolt head (31) connected to a bolt head operator (32), the pivotable bolt head (31) being pivotable around an axis (A) extending from the upper end (11) to the lower end (12) of the housing,—a catch (22) for blocking pivoting of the bolt head (31) in a blocked state of the locking device (1), and—a catch receiver (21) for receiving the catch (22) in an unblocked state of the locking device (1), and further comprising an activation mechanism (40) comprising an activation unit (41) and a transfer mechanism (49) for transferring a movement from the activation unit (41) to the bolt head operator (32), wherein the bolt head operator (32) comprises a control member (33) for controlling the state of the catch (22), wherein rotation of the control member (33) causes the catch receiver (21) to become available to the catch (22) for forming the unblocked state.

### TECHNICAL FIELD

The present invention relates to a locking device having a bolt with a pivotable bolt head and a catch that blocks pivoting of the pivotable bolt head in a blocked state, the locking device also having an activation mechanism for moving to an unblocked state in which the pivotable bolt head is able to pivot.

### BACKGROUND

Within the field of locking devices, bolts are generally movable between an extended position that corresponds to a closed or locked state and a retracted position that corresponds to an open or unlocked state. Some bolts comprise a bolt head that is collapsible, i.e. pivotable about a vertical axis, and this has the advantage of enabling opening or closing of the door without having to operate a handle in order to retract the bolt. In a locked state, a catch is generally provided to prevent undesired pivoting of the bolt head.

In a locking device with electromechanical actuation, it is desirable to open the door remotely without requiring any mechanical activation of the lock itself such as by pivoting a handle. This may take place by pressing a button, using an electronic identification such as a keycard or tag, or in response to a sensor input signifying that a person approaches the door. However, in order to comply with fire regulations, it must also be ensured that an open door is always able to close in an emergency to prevent the spread of fire. Such emergency functions must also be available even if power supply to the locking device is interrupted so that the electromechanical activation is prevented.

There are some available locking devices that attempt to resolve these problems, but they require improvements to be able to operate in an efficient and reliable way during normal operation while at the same time providing a stable and reliable emergency operation.

There is therefore a need for further improvements within this area.

### SUMMARY

The object of the present invention is to eliminate or at least to minimize the problems discussed above. This is achieved by a locking device according to the appended independent claim. Advantageous embodiments and variants are set forth in the dependent claims.

The locking device according to the invention comprises a housing having an upper end and a lower end, and also having a bolt opening in a first side extending from the upper end to the lower end. There is also a first bolt comprising a pivotable bolt head connected to a bolt head operator and configured to move linearly from an extended state where it protrudes through the bolt opening to a retracted state, the pivotable bolt head being pivotable around an axis extending from the upper end to the lower end. The locking device further comprises a catch for blocking pivoting of the bolt head in a blocked state of the locking device and a catch receiver for receiving the catch in an unblocked state of the locking device.

Also, the locking device comprises an activation mechanism for operating the locking device, the activation mechanism comprising an activation unit and a transfer mechanism for transferring a movement from the activation unit to the bolt head operator. The bolt head operator comprises a control member configured to be rotated by the transfer mechanism for controlling the state of the catch, wherein rotation of the control member causes the catch receiver to become available to the catch for forming the unblocked state.

A main advantage of the locking device of the present invention is the unblocking of the catch by the operation of the activation unit. This ensures that the door can be opened automatically without requiring retraction of the first bolt into the locking device by mechanically rotating a handle or by electromagnetically operated means that retract the first bolt. Instead, the unblocked state enables pivoting or collapsing of the bolt head when the bolt head contacts a strike plate so that the bolt is then retracted simply by the interaction of the first bolt with the strike plate as such. Also, the locking device is configured to move back to the blocked state when the activation mechanism is not active by the interaction of the transfer mechanism and the control member, and in this way the locking device is ready for emergency closing at any time and the blocked state prevents opening of the door. Another advantage is the arrangement of the control member to rotate in order to render the catch receiver available to the catch, since this is a significantly more space efficient design than prior art solutions where a catch is controlled by a linear operation of an operator or fixture.

Suitably, the catch receiver is inside the bolt head operator and rotation of the control member enables the catch to at least partially enter an opening of the catch receiver. Thereby, a compact solution is presented in which the catch is housed inside the bolt head operator in the unblocked state.

The transfer mechanism may also comprise a transfer element and a coupler, said transfer element being connected to the activation unit and said coupler being configured to couple a movement from the transfer element to the bolt head operator. Thereby, the coupling of movement from the activation mechanism takes place by the interaction of two components, allowing for the coupler to transfer a selected part of the movement of the transfer element to the control member. This in turn allows for a versatile operation of the control member where the rotation may take place as soon as the activation unit is activated or at a later time during movement of the transfer element.

Suitably, the transfer element is configured to move along a transfer element path and to contact the coupler at an end of the transfer element path. Thereby, the transfer element may control other functions of the lock that should take place before the control member is rotated to achieve the unblocked state of the catch. Such functions may include operating a second bolt.

Also, there may be a coupler biasing device configured to bias the coupler towards the blocked state. Thereby, the locking device will return to the blocked state as soon as the transfer element no longer applies a force to the coupler, ensuring that the bolt head is prevented from pivoting in all situations except when the activation mechanism is active and the transfer element acts on the coupler.

Suitably, the activation unit is configured to act with a transfer force on the transfer element for moving the transfer element along the transfer element path, and the coupler biasing device has a bias that is smaller than the transfer force but larger than a back force required to force the transfer element back to a neutral position when the activation unit is not active. Thereby, the locking device is able to reach the blocked state also in situations where a loss of power occurs or where the activation unit malfunctions. In such situations, the coupler will push the transfer element away and will simultaneously rotate the control member to reach the blocked state, thereby preventing rotation of the bolt head.

The control member of the bolt head operator may comprise a forward portion and a rear portion that are rotationally stable and telescopic such that a rotation is transferred from one portion to the other whereas a linear movement is not. This is highly advantageous in achieving a compact locking device where retraction of the first bolt takes place without requiring additional space to house the bolt head operator in the retracted position. That the forward portion and the rear portion are rotationally stable ensures that the unblocked state can always be reached when the control member is rotated.

Suitably, the locking device includes a bolt head biasing device configured to bias the bolt head towards a non-pivoted position. Thereby, the bolt head strives to its original position at all times so that the catch is always able to block the bolt head when desired.

In some embodiments, the catch is a ball, and the catch receiver is at least one hollow in the bolt head operator for receiving the ball in the unblocked state. Thereby, the catch is housed in the bolt head operator partly or entirely in the unblocked state, rendering the locking device even more compact and reliable.

Also, the locking device may comprise a handle connector that is connected to the bolt head operator for retracting the bolt head to the retracted state in response to a rotation of a handle mounted in the handle connector. Thereby, a mechanical operation of the first bolt is also enabled and may be used to retract the bolt head both when the locking device is in the blocked state and when it is in the unblocked state.

Suitably, the locking device comprises a second bolt that is operated by the activation mechanism via the transfer mechanism, wherein the second bolt is configured to be retracted from an extended state during a first part of the transfer element along the transfer element path. Thereby, the activation mechanism operates both bolts simultaneously in such a way that retraction of the second bolt is at least initiated, and optionally completed, before the control member is operated to bring the first bolt to the unblocked state. This ensures that an open state is reached where the door can be opened by automatic means or by a person pushing or pulling on the door without risking jamming resulting from the second bolt still being in the extended position when the bolt head is unblocked. This ensures reliable operation of the door, especially in an emergency where excessive force on a still locked door could otherwise result in the door remaining shut due to the second bolt being fixed against the strike plate.

Many additional benefits and advantages of the present invention will be readily understood by the skilled person in view of the detailed description below.

### DRAWINGS

The invention will now be described in more detail with reference to the appended drawings, wherein

FIG. 1a discloses a perspective view of a locking device according to the invention in a neutral position and a blocked state;

FIG. 1b discloses the locking device of FIG. 1a in a cross-sectional view;

FIG. 2a discloses a perspective view of the locking device in a neutral position and an unblocked state;

FIG. 2b discloses the locking device of FIG. 2a in a cross-sectional view;

FIG. 3a discloses a perspective view of the locking device in the unblocked state with the bolt head pivoted;

FIG. 3b discloses the locking device of FIG. 3a in a cross-sectional view;

FIG. 4a discloses a perspective view of the locking device in the unblocked state with the bolt head pivoted and the first bolt retracted;

FIG. 4b discloses the locking device of FIG. 4a in a cross-sectional view;

FIG. 5a discloses a perspective view of the locking device in the blocked state with the first bolt retracted;

FIG. 5b discloses a perspective view of the locking device in the blocked state with the first bolt returned to the extended position;

FIG. 6 discloses a perspective view of a second embodiment of the invention in the blocked state and the neutral position;

FIG. 7 discloses a perspective view of the second embodiment in the blocked state with the first bolt retracted;

FIG. 8a discloses a planar view of a third embodiment of the invention in the blocked state and the neutral position;

FIG. 8b discloses a perspective view of the locking device of FIG. 8a;

FIG. 9a discloses a planar view of the third embodiment in the blocked state with a second bolt partially retracted;

FIG. 9b discloses a perspective view of the locking device of FIG. 9a;

FIG. 10 discloses a planar view of the third embodiment in the blocked state with the second bolt retracted; and

FIG. 11 discloses a planar view of the third embodiment in the unblocked state with the first bolt and the second bolt retracted.

All the figures are schematic, not necessarily to scale, and generally only show parts which are necessary in order to elucidate the respective embodiments, whereas other parts may be omitted or merely suggested. Any reference number appearing in multiple drawings refers to the same object or feature throughout the drawings, unless otherwise indicated.

### DETAILED DESCRIPTION

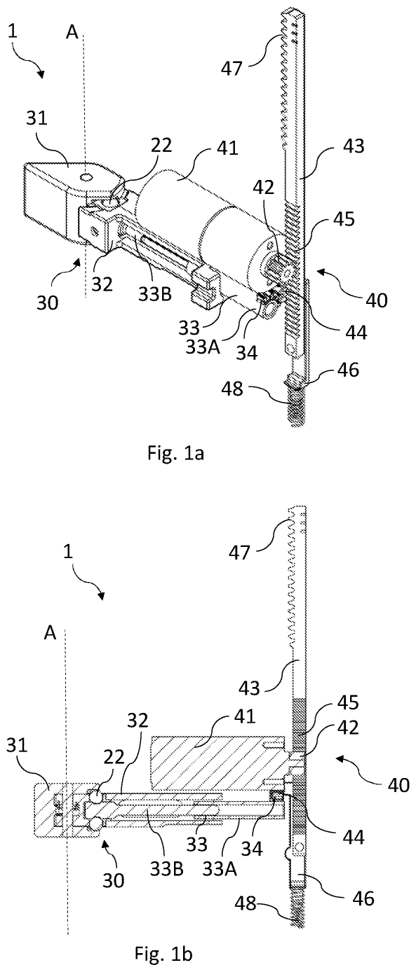

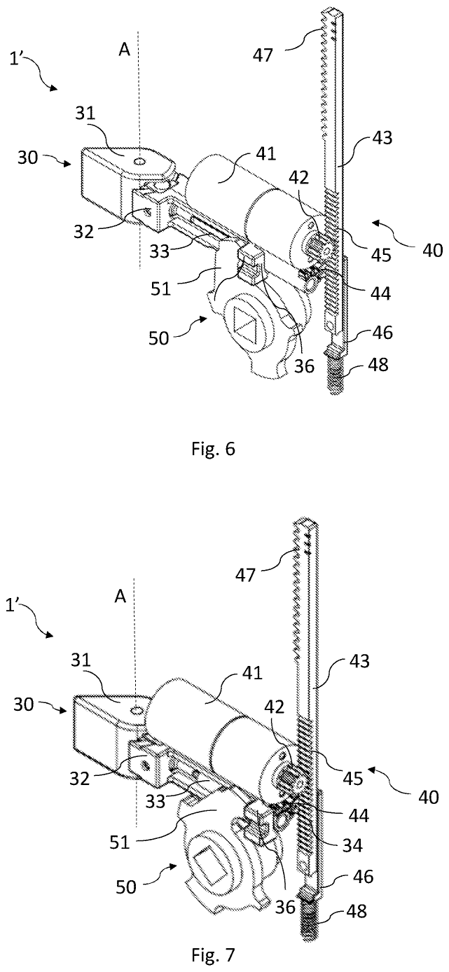

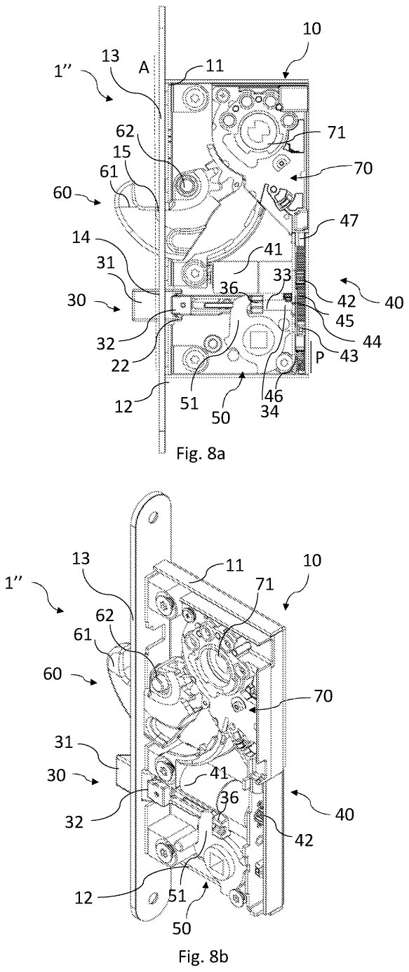

The locking device according to the invention will now be described in more detail, starting with a first embodiment shown in FIG. 1a-5b. Then, a second embodiment with a handle operator shown in FIG. 6-7 will be described, followed by a third embodiment with a second bolt shown in FIG. 8-11.

It is to be noted that what is said herein with reference to one embodiment also applies equally to any other embodiment, except where explicitly stated otherwise. Also, features from one embodiment may be freely implemented into any other embodiment unless such a combination is explicitly stated as unsuitable or undesirable.

When it is said herein that a component is connected to another component, this is to be understood as the components being connected in such a way that a movement or a force can be transferred from one component to the other in at least one direction. They may be connected directly or with at least one intermediate component for transferring the force or movement.

FIG. 1a-1b show the first embodiment of the locking device 1 according to the invention in a neutral position and a blocked state. The neutral position is a position where a first bolt 30 is extended, and the blocked state is a state in which a catch 22 is in a blocking position and prevents collapsing or rotation of a bolt head 31 around an axis A. The axis A is an axis that extends from a first end 11 or upper end 11 of a housing 10 to a second end 12 or lower end 12 (see FIG. 8a), and that is substantially vertical when the locking device 1 is mounted in a door.

The term “substantially vertical” or “substantially spherical” as used herein is to be understood as vertical or spherical within manufacturing tolerances and/or mounting tolerances.

Biasing devices as disclosed herein may comprise metal springs, such as extension springs, compression springs or blade springs, among others. Alternatively, any other devices that are able to apply a bias may be used as the biasing devices.

The locking device 1 comprises the first bolt 30 that in turn comprises the bolt head 31 and a bolt head operator 32 that is connected to the bolt head 31 so that the bolt head 31 can be retracted in a linear movement by the bolt head operator 32. The catch 22 is in this first embodiment held between the bolt head operator 32 and the bolt head 31 in the blocked state so that pivoting of the bolt head 31 is prevented, e.g. by the bolt head 31 contacting the catch 22. In this embodiment, the catch 22 is a ball that is substantially spherical, but it may alternatively be oval or any other shape as long as it is able to prevent rotation of the bolt head 31.

The locking device 1 also comprises an activation mechanism 40 for operating the locking device 1 and more specifically for moving the locking device 1 from the blocked to the unblocked state. In some embodiments, the activation mechanism 40 serves multiple functions in the locking device 1 (such as operating a second bolt or retracting the first bolt) but it may also have controlling the blocked/unblocked state as its sole function.

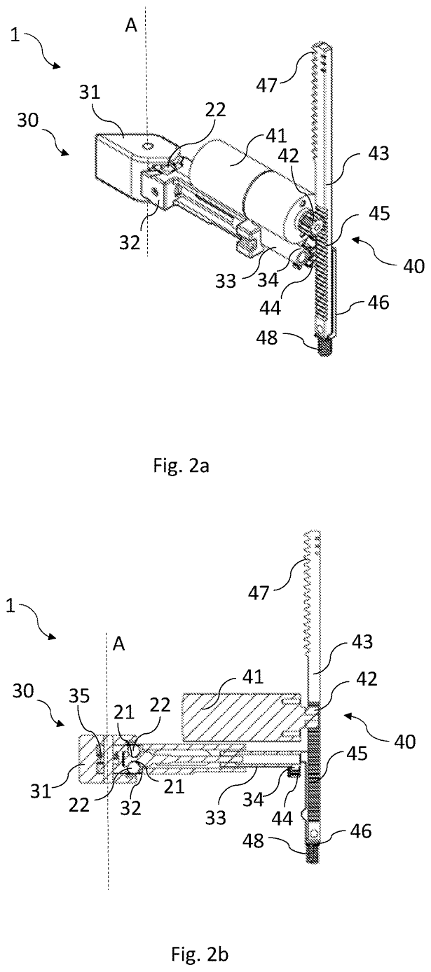

The activation mechanism 40 comprises an activation unit 41 and a transfer mechanism 49 that is configured to transfer a movement from the activation unit 41 to a control member 33 of the bolt head operator 32. In this embodiment, the activation unit 41 is an electrical motor that contacts the transfer mechanism 49 by an extended toothed member 42 interacting with corresponding teeth in a first toothed section 45 on a bar 43, but in other embodiments the activation unit 41 could instead be a solenoid operating a plunger or any other electromagnetic activation means. Also, the transfer mechanism 49 may comprise a single element such as a bar that is coupled directly to the extended toothed member 42 and to the control member 33, or it may alternatively comprise a plurality of elements that are linked such that a movement can be transferred from the activation unit 41 to the bolt head operator 32. In the first embodiment, the transfer mechanism 49 comprises a bar or rack 43 and a coupler 46 that couples movement to the control member 33. There is also a coupler biasing device 48 that is configured to bias the coupler 46 towards the blocked state, i.e. the towards the neutral position of FIG. 1a-1b. The activation unit 41 is configured to act on the transfer mechanism 49 with a transfer force that causes the transfer mechanism 49 to move to the position shown in FIG. 2a-2b.

In the first embodiment, the control member 33 of the bolt head operator 32 comprises a rear portion 33A and a forward portion 33B that are arranged in a rotationally stable manner. This means that a rotation of one of the rear portion 33A and the forward portion 33B is transferred to the other. The rear portion 33A and the forward portion 33B are also telescopic, such that a linear movement of one of the rear portion 33A and the forward portion 33B is not transferred to the other. More specifically, in the first embodiment a retraction of the first bolt 30 causes the forward portion 33B to be pushed into the rear portion 33A so that the bolt head 31 is retracted as desired but that the rear portion 33A of the control member 33 is not linearly displaced. In some embodiments, the rear portion 33A could instead enter the forward portion 33B or there could be more than two portions of the control member 33 where at least one portion is able to enter at least one other portion. In other embodiments, the control member 33 is not telescopic but instead comprises one portion or several portions that are fixedly attached to each other.

Operation of the locking device 1 will now be explained with reference to FIG. 1a-5b. In FIG. 1a-1b, the locking device 1 is in the neutral position, i.e. a rest position that each component of the locking device 1 is in when not subjected to an activation by the activation mechanism 40 (or a mechanical activation as described further below) or to an external force on the first bolt 30 or on any other component.

Activation of the activation mechanism 40 may take place in any known manner, such as by a user (e.g. pressing a button or using a keycard or tag on a panel or other receiving unit that communicates through wired or wireless connection with the activation unit 41) or in response to an opening command by another unit (e.g. a sensor detecting the presence of a person near the door, or a remote controller that communicates with the activation unit 41 by any suitable means). Such activation means are well known within the art and will not be described in more detail herein. Suffice it to say that an activation command is transmitted to the activation unit 41 and that the activation unit 41 responds by starting the electric motor of the first embodiment. This causes rotation of the extended toothed member 42 that meshes with the toothed section 45 of the bar or rack 43 such that the bar or rack 43 moves towards the coupler 46, i.e. downwards in the Figures. This causes the coupler 46 to be pushed against the bias of the coupler biasing device 48 and transfers the movement to the control member 33 by a first interaction portion 44 on the coupler 46 interacting with a second interaction portion 34 on the control member 33 so that the control member 33 is rotated. The first and second interaction portions 44, 34 are in the first embodiment toothed portions that mesh with each other, but in other embodiments they could be of any other design that is suitable for transferring a movement from one component to another.

Rotation of the control member 33 causes a catch receiver 21 to become available to the catch 22. In the first embodiment, the catch receiver 21 is a hollow or indentation in the control member 33 into which the catch 22 is able to move in order to enter at least partially when the control member 33 is in the rotated position. This forms the unblocked state, where the catch 22 is no longer held between the bolt head operator 32 and the bolt head 31 in such a way that pivoting of the bolt head 31 is prevented. In some embodiments, the catch receiver 21 can be formed by the control member 33 having an internal space inside which the entire catch 22 can be held, but in other embodiments the catch 22 only enters the catch receiver 21 partially, as long as the bolt head 31 is able to pivot without being hindered by the catch 22. As shown in the Figures, the first embodiment comprises two catches 22 that are provided at an upper end and a lower end of the bolt head operator 32, and the control member 33 comprises two catch receivers 21 that are made available to each of the catches 22 when the control member 33 is rotated. This is advantageous in distributing the force evenly when the bolt head 31 acts on the catches 22 in the blocked state. However, it is to be noted that a single catch 22 is sufficient to achieve the advantages of the present invention, and that other embodiments could also include a plurality of catches rather than the two shown in the Figures.

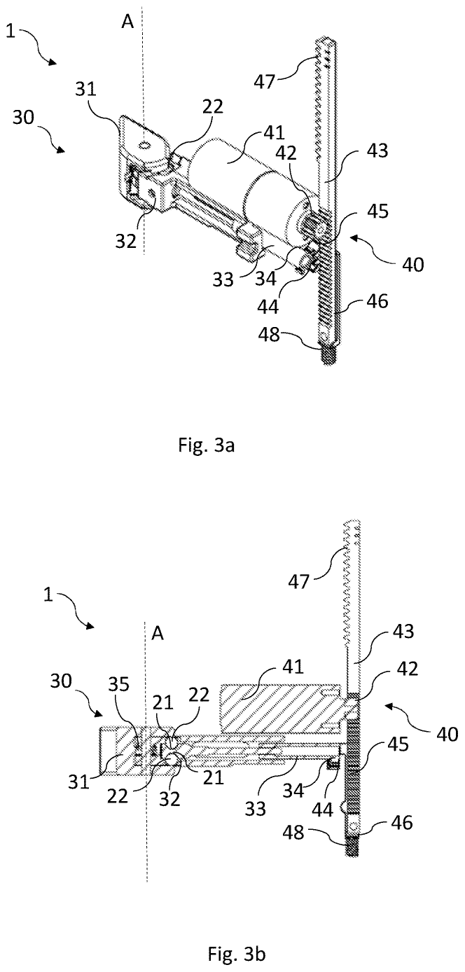

Thus, rotation of the control member 33 controls the state of the catch 22 by making the catch receiver 21 available or unavailable to the catch 22. In the unblocked state of FIG. 2a-2b, the bolt head 31 is able to rotate when subjected to a force against a front surface 31A of the bolt head 31 itself. Typically, the locking device 1 is mounted in a door so that the first bolt 30 enters an opening in a strike plate of a door jamb (not shown), and when the locking device 1 is in the unblocked state the door can be opened by a person pushing or pulling on the door or by an automatic opening (not shown). When the door opens, the front surface 31A of the bolt head 31 is pushed with an opening force against an edge of the opening in the strike plate and pivots to a pivoted position shown in FIG. 3a-3b. In order for the bolt head 31 to be pivotable, the transfer mechanism 49 must remain in the position of FIG. 2a-2b so that the control member 33 is rotated and the catch receiver 21 is available for the catch 22.

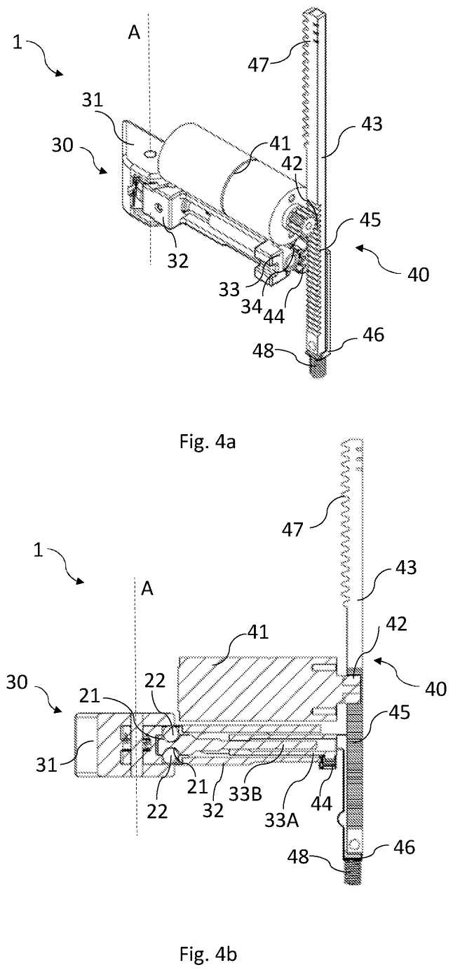

When the bolt head 31 is in the pivoted position, the opening force causes the bolt head 31 to be retracted in a linear motion to reach a retracted position shown in FIG. 4a-4b. Thus, the unblocked state of the catch 22 enables both rotation of the bolt head 31 and retraction of the bolt head 31 in this way, since an opening force will not cause the retraction unless the bolt head 31 is in the pivoted position. FIG. 4a-4b also show the telescopic design of the control member 33 where the forward portion 33B is retracted into the rear portion 33A whereas the rear portion 33A has not moved from its position in FIG. 3a-3b.

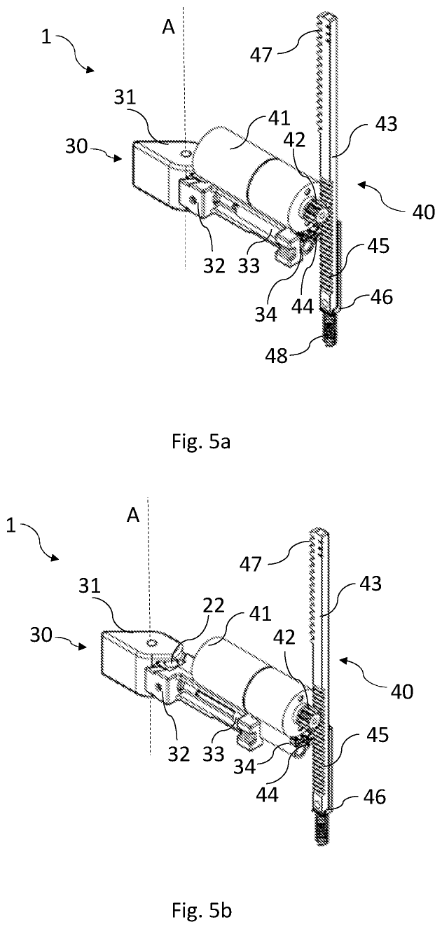

Once the pivoted and retracted position in FIG. 4a-4b has been reached, the door is free to open. Suitably, the first bolt 30 comprises a bolt head biasing device 35 that biases the bolt head 31 towards the non-pivoted or neutral position so that the bolt head 31 is urged back to this position as soon as the opening force from the strike plate ceases. This retracted and non-pivoted position is shown in FIG. 5a. Also, the first bolt 30 suitably comprises a first bolt biasing device (not shown) that biases the first bolt 30 towards the extended position so that the position shown in FIG. 5b is reached where the bolt head 31 is non-pivoted and the first bolt 30 is extended.

As also shown in FIG. 5a-5b, the transfer mechanism 49 is returned to the neutral position as soon as the activation unit 41 ceases to move the transfer element 43 towards the coupler 46. The coupler biasing device 48 facilitates this by pushing the coupler 46 to the neutral position which causes rotation of the control member 33 to the blocked position where the catch receiver 21 is no longer available to the catch 22. When the bolt head 31 is returned to the non-pivoted position, this renders the bolt head 31 blocked to prevent further pivoting. In the first embodiment, the bolt head biasing device 35 urges the bolt head 31 to the non-pivoted position whereas the catch 22 only serves to block the bolt head 31 from pivoting once the non-pivoted position is reached. In some embodiments, however, the catch 22 could also serve to return the bolt head 31 to the non-pivoted position, e.g. by interacting with a beveled surface of the bolt head 31 so that rotation of the control member 33 pushes the catch 22 towards the beveled surface of the bolt head 31 and forces the bolt head 31 back to the non-pivoted position.

Once the bolt head 31 is returned to the non-pivoted position and the first bolt 30 is extended, releasing the door and allowing it to swing back towards the strike plate causes both closing and locking of the door since the contact with the strike plate causes retraction of the now non-pivoted bolt head 31 to allow the closing of the door and the re-entry of the bolt head 31 into the opening in the strike plate. This is highly advantageous from a safety standpoint since it enables locking of the door in an emergency such as a fire where the door must be reliably closed and locked to prevent the spread of fire. It is particularly advantageous that the activation mechanism 40 operates to return the locking device 1 to the blocked state as soon as the activation unit 41 no longer operates to cause the unblocked state. This means that a loss of power will not hinder the return to the blocked state and that the locking device 1 is in the blocked state at all times except when the activation unit 41 is active. In the first embodiment, the coupler biasing device 48 is strong enough to push against the coupler 46 with at least a back force that causes movement of the transfer mechanism 49 in a powerless state, i.e. the force required to force the extended toothed portion 42 to rotate in an opposite direction. This means that a loss of power when the transfer mechanism 49 is in the position of FIG. 2a-2b, i.e. when the control member 33 is rotated to reach the unblocked state, cannot hinder the return to the blocked state. This means that the bias provided by the coupler biasing device 48 is stronger than the force needed to cause the activation mechanism to return to its neutral position but not stronger than the transfer force supplied when the activation unit 41 is activated, since the coupler 46 must be moved against the bias in order for the non-blocked state to be achieved.

In some embodiments, the activation mechanism 40 is configured to retract the first bolt 30 to the retracted position so that opening of the door is further facilitated. In other embodiments, the activation mechanism 40 only rotates the control member 33 to reach the unblocked state so that retraction of the first bolt 30 takes place by the interaction with the strike plate as explained above.

FIG. 6 discloses the locking bolt 1′ according to a second embodiment of the invention that differs from the first embodiment described above by the addition of a handle connector 50 that enables operation of the first bolt 30 by manually turning a handle (not shown) mounted in the handle connector 50. Apart from this addition, the second embodiment is similar or identical to the first embodiment and the same reference numerals are used throughout.

The handle connector 50 comprises a connector member 51 that extends from the handle connector 50 towards a bolt head operator member 36 that is connected to the bolt head operator 32. In FIG. 7, the locking device 1′ is shown in a blocked state with the first bolt 30 retracted by rotation of the handle connector 50 that causes the connector member 51 to push against the bolt head operator member 36 and thereby move the first bolt 30 to the retracted position. The catch 22 remains in the blocked state unless the activation mechanism 40 is activated, regardless of the rotation of the handle connector 50.

The second embodiment thus enables manual opening of the door in which the locking device 1′ is mounted by allowing a person approaching the door to pivot the handle and thereby cause a retraction of the first bolt 30.

It is in particular to be noted that the inclusion of the handle connector 50 does not interfere with any of the design or function of the locking device 1 as described with reference to the first embodiment above. When the first bolt 30 is retracted by interaction with the strike plate or by retraction by the activation mechanism 40 as provided in some embodiments, the connector member 51 is not in contact with the bolt head operator member 36 and so does neither contribute to nor hinder the movement of the first bolt 30.

FIG. 8a-11 show a third embodiment of the locking device 1″ that differs from the first embodiment described above by including both the handle connector 50 of the second embodiment and a second bolt 60 that is operated by the activation mechanism 40. It also shows the housing 10 in which the components of the locking device 1″ are arranged. Apart from this addition, the second embodiment is similar or identical to the first embodiment and the same reference numerals are used throughout.

Thus, in FIG. 8a-8b the upper end 11 of the housing 10 is shown together with the lower end 12. The first bolt 30 is arranged to protrude through a bolt opening 14 in a first side 13 and the second bolt 30 is arranged to protrude through a second bolt opening 15 in the first side 13. The first side 13 is a side that faces the strike plate when the locking device 1″ is mounted in a door and when that door is closed. The axis A around which the bolt head 31 is pivotable is parallel to or coinciding with the first side 13, i.e. extends from the upper end 11 to the lower end 12.

The second bolt 60 is shown as a hook bolt 61 that is pivotable on a hook bolt pivot 62 around an axis that is perpendicular to the axis A, but it is to be noted that the second bolt 60 can be any kind of bolt suitable for use in a locking device. In the third embodiment, the second bolt 60 is operated by a second bolt operating mechanism 70 that may be any suitable mechanism for transferring a movement to the hook bolt 61 for retracting or extending the hook bolt 61. The activation mechanism 40 as shown in the first embodiment and the second embodiment comprises an additional section 47 that is connectable to the second bolt operating mechanism 70 when used in the locking device 10″ of the third embodiment. Thus, the additional section 47 is coupled to the second bolt operating mechanism 70 in any suitable way so that an activation of the activation unit 41 and the subsequent movement of the transfer mechanism 49 causes this movement to be transferred to the second bolt operating mechanism 70 so that the second bolt 60 is retracted. Suitably, the activation mechanism 40 is configured to return to the neutral position after the unblocked state has been achieved. Also, the third embodiment of the locking device 10″ may comprise a manual activation of the second bolt operating mechanism 70 that is achieved by providing a follower 71 into which a cylinder can be inserted for operation by a key or a turnable knob or tab. The follower 71 is then connected to the second bolt operating mechanism 70 so that manual retraction and extension of the second bolt 60 is enabled in a manner known in the art.

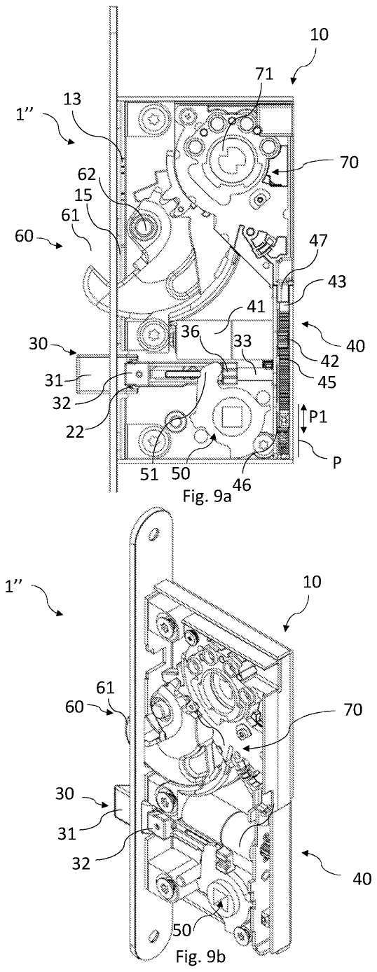

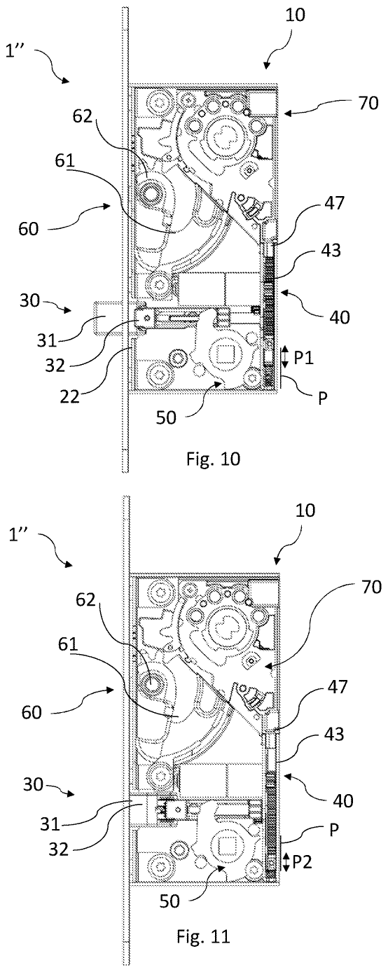

One particular advantage of the third embodiment is that the second bolt 60 is retracted before the unblocked state of the first bolt 30 is reached. This is achieved by the transfer element 43 being configured to move along a transfer element path P and to contact the coupler 46 at an end of the transfer element path P. This enables the movement of the transfer element 43 along a first part P1 of the path P to be transferred to the second bolt operating mechanism 70 without affecting the control member 33 so that the blocked state is retained. This is shown in FIG. 9a-9b where the transfer element 43 moves along the first part P1 of the path P and the second bolt 60 is partially retracted. In FIG. 10, the transfer element 43 is at the end of the first part P1 and the second bolt 60 is fully retracted. FIG. 11 shows the transfer element 43 at the end of the path P. During a second part P2 of the path P, the transfer element 43 pushes against the coupler 46 and this causes the unblocked state as described above with reference to the other embodiments. The first bolt 30 is then retracted, suitably by contact with the strike plate as described above for the first embodiment, to reach the position of FIG. 11 where both bolts 30, 60 are retracted. In some embodiments, the activation unit 41 rotates the extended toothed section 42 to move the transfer mechanism 49 to another, elevated position that causes the second bolt 60 is extended again. In other embodiments, return of the second bolt to the extended position may take place when the activation mechanism 40 is returned to its neutral position or by any other action by the activation mechanism or by manual operation of the second bolt operating mechanism 70.

It is to be noted that the inclusion of the additional components in the third embodiment of the locking device 10″ does not interfere with the function of the invention as described for the first embodiment. Thus, the design and operation of the locking device 1 of the first embodiment is similar or identical to the operation of the locking device 1″ of the third embodiment except where it is explicitly stated that they differ.

It is to be noted that features from the various embodiments described herein may freely be combined, unless it is explicitly stated that such a combination would be unsuitable.

1. A locking device for operating a first bolt (30), the locking device (D) comprising
a housing (10) having an upper end (11) and a lower end and also having a bolt opening (14) in a first side (13) extending from the upper end (11) to the lower end (12),
a first bolt (30) comprising a pivotable bolt head (31) connected to a bolt head operator (32) and configured to move linearly from an extended state where it protrudes through the bolt opening (14) to a retracted state, the pivotable bolt head (31) being pivotable around an axis (A) extending from the upper end (11) to the lower end (12),
a catch (22) for blocking pivoting of the bolt head (31) in a blocked state of the locking device (1), and
a catch receiver (21) for receiving the catch (22) in an unblocked state of the locking device (1),
and further comprising
an activation mechanism (40) for operating the locking device (1), the activation mechanism (40) comprising an activation unit (41) and a transfer mechanism (49) for transferring a movement from the activation unit (41) to the bolt head operator (32),
wherein the bolt head operator (32) comprises a control member (33) configured to be rotated by the transfer mechanism (49) for controlling the state of the catch (22), wherein rotation of the control member (33) causes the catch receiver (21) to become available to the catch (22) for forming the unblocked state.

2. The locking device according to claim 1, wherein the catch receiver (21) is inside the bolt head operator (32) and wherein rotation of the control member (33) enables the catch to at least partially enter an opening of the catch receiver (21).

3. The locking device according to claim 2, wherein the transfer mechanism (49) comprises a transfer element (43) and a coupler (46), said transfer element (43) being connected to the activation unit (41) and said coupler (46) being configured to couple a movement from the transfer element (43) to the bolt head operator (32).

4. The locking device according to claim 3, wherein the transfer element is configured to move along a transfer element path (P) and to contact the coupler at an end of the transfer element path (P).

5. The locking device according to claim 4, further comprising a coupler biasing device configured to bias the coupler (46) towards the blocked state.

6. The locking device according to claim 5, wherein the activation unit (41) is configured to act with a transfer force on the transfer element (43) for moving the transfer clement (43) along the transfer element path (P), and wherein the coupler biasing device (48) has a bias that is smaller than the transfer force but larger than a back force required to force the transfer element (43) back to a neutral position when the activation unit (41) is not active.

7. The locking device according to claim 1, wherein the control member (33) of the bolt head operator (32) comprises a forward portion (33B) and a rear portion (33A) that are rotationally stable and telescopic such that a rotation is transferred from one portion to the other whereas a linear movement is not.

8. The locking device according to claim 1, further comprising a bolt head biasing device (35) configured to bias the bolt head (31) towards a non-pivoted position.

9. The locking device according to claim 1, wherein the catch (22) is a ball and wherein the catch receiver (21) is a hollow in the bolt head operator (32) for receiving the ball in the unblocked state.

10. The locking device according to claim 1, further comprising a handle connector (50) that is connected to the bolt head operator (32) for retracting the bolt head (31) to the retracted state in response to a rotation of a handle mounted in the handle connector (50).

11. The locking device according to claim 4, further comprising a second bolt (60) that is operated by the activation mechanism (40) via the transfer mechanism (49), wherein the second bolt (60) is configured to be retracted from an extended state during a first part (P1) of the transfer element path (P) along which the transfer element (43) is configured to move.
